(19) United States
(12) Patent Application Publication
(10) Pub. No.: US 2004/0022376 A1
(43) Pub. Date: Feb. 5, 2004

(54) Universal interface device driver system

(76) Inventors: Gary Jurman, Tampa, FL (US); Franklin Veaux, Tampa, FL (US)

Correspondence Address: FOWLER WHITE BOGGS BANKER, P.A., 501 E. KENNEDY BOULEVARD, SUITE 1700, TAMPA, FL, 33602, US

(21) Appl. No.: 10/209,393

(22) Filed: Jul. 31, 2002

(51) Int. Cl. H04M 11/00

(52) U.S. Cl. 379/102.01

(57) ABSTRACT

The present invention is a system allowing a user to remotely control operable or manipulative devices through a telecommunications network and a Universal Controller interconnected with a host device. The Universal Controller receives signals in the form of audio (preferably DTMF) tones from the host device and controls the operable or manipulative devices as directed by these signals. The host device can be a personal computer, a touch-tone telephone, or any communications device that is capable of generating audio tones. The present invention also includes a method allowing a user to remotely control devices through an acoustically driven Universal Controller. The method uses a Universal Device Driver connected to a host computer that responds to a TCP/IP or other networking protocol request from a client computer by displaying a notification and enabling a decision to accept or reject the request, whereby establishing a connection between the host computer and the client computer. After the connection is established, the method uses a Universal Controller, connected to the host computer, to control operable or manipulative devices in response to audio (preferably DTMF) tones. As presently implemented, the method is characterized by the software adapting to a demand mode, and subsequently on demand to a command mode, whereby to enable the present invention to act on a command.

### FIELD OF THE INVENTION

This invention relates to a system and a method for controlling computer peripheral devices. More specifically, it relates to a system and a method for controlling devices that use a computer sound port as the connection port for the devices and audio tones as controlling signals.

### BACKGROUND OF THE INVENTION

Device drivers are programs or routines, which control and manage peripheral devices attached to data processing systems. The drivers form part of and interact with an operating system, that normally includes a basic set of device drivers for peripheral devices commonly used with data processing systems such as keyboards, fixed and floppy disk drives, displays, and printers. When a peripheral device is added to a data processing system, and such device is not operable under an existing driver stored within the data processing system, a new driver must be added to the system in order to use the device. A new driver is customarily supplied by the maker of the peripheral device and is installed in the system in accordance with procedures established by the operating system. In personal computers using the DOS™ or OS/2™ operating systems, such drivers are installed at start or reboot time, using commands or instructions in a CONFIG.SYS file.

Typically device drivers are created for use with a particular operating system. A device driver written for one operating system cannot be used with another operating system without extensive modifications. Many have tried to solve this dependency problem in order to create a universal device driver. One example is U.S. Pat. No. 5,265,252 to Rawson et al., which discloses a device driver, with one part that interfaces with a specific operating system and a second part that interfaces with a plurality of different operating systems. Another example is U.S. Pat. No. 4,975,829 to Clarey et al., which also discloses a device driver that is independent of a computer operating system for communication with peripheral devices.

The prior art, as noted above, exhibits an apparent universal connectivity feature for operating systems and peripheral devices whose protocols are programmed into the device driver. However, these device drivers are activated at compile time and thus cannot interact with operating systems or device drivers not known of during the authoring of the initial device driver. Thus, these device drivers fail to achieve true independence.

Recently, Tektronix and others began writing Hyper-Text Mark Up Language (HTML) software for peripheral devices allowing users to link peripheral devices to the Internet. HTML allows for two-way communication between a connected host and the peripheral device. However, the host must include the device driver software to operate with the peripheral. For example, if a user is to print an MS Word Document to a printer identified by an addressed site on the Internet or similar type network, the user must first send the document through the device driver associated with this printer. Then the user must utilize a send document function, such as a File Transfer Protocol (FTP) procedure, to efficiently deliver the document to the printer.

U.S. Pat. No. 5,881,317 issued to Hampsten, et al. on Mar. 9, 1999 titled “Adaptive Operation of Audio Peripherals Based on the Functionality of Analog Audio Interface” discloses a computer system provided with a device driver for adaptively operating a number of audio peripherals through a pair of digital audio controller and analog audio interface, in accordance with the audio functions supported by the analog audio interface, including for at least one audio function, the kind of support being provided. The analog audio interface includes one or more control registers for storing a number of functional indicators to indicate the audio functions supported, and for the at least one audio function, the support kind. The analog audio interface further includes a number of control registers for storing control information for modifying the behavior of the supported audio function. This control information includes a number of enabling/disabling indicators and a number of power management indicators to allow the device driver to selectively operate certain ones of a number of independently powered components of the audio analog interface. In a co-pending U.S. patent application Ser. No. 08/673,282, entitled “Audio Serial Digital Interconnect”, filed on Jun. 28, 1996, and having common inventorship as well as assignee with the above discussed invention, a split architecture employing a digital controller and the analog audio interface can be manufactured by a large number of different vendors. In other words, it is manufactured by any one of a number of manufacturers, in conjunction with an analog audio interface manufactured by the same or any one of a number of other manufacturers.

This present system and its associated method address the disadvantages of the prior art in several novel ways. The most novel of this system's innovations is in its computer interface. This system controls operable and manipulative peripheral devices by using a host computer's sound system to generate signals in the form of audio tones. Although other audio tones may be used, the system preferably uses Dual-Tone Multi-Frequency (“DTMF”) tones because these are the same tones used by touch-tone telephones. The system's Universal Controller decodes these tones using a tone decoder integrated circuit on the system's circuit board and based on the received audio tone, decides which output(s) to activate or deactivate.

This approach solves several problems. First it works on virtually any computer regardless of port configuration. Now and for the foreseeable future, nearly every personal computer sold includes a sound output as a feature. This system does not rely on ports such as USB, which do not exist on older computers. Moreover, this system is more reliable than the prior art approaches.

Second, the system is electronically and programmatically very simple. It requires no driver-level software (such as a USB approach would require), no onboard intelligence, no onboard bus transceiver or interface logic, and no onboard microprocessor or firmware. Tone decoding is handled by an off-the-shelf DTMF decoder designed for the telecommunications market; no custom parts or firmware are required.

Third, the system can be used on virtually any sort of platform. Currently, prototype software exists for Windows personal computers, Macintosh systems running MacOS Classic, and Macintosh systems running MacOS X. Because the software does not require any device driver level component and works with Transmission Control Protocol/Internet Protocol (TCP/IP), the software can be deployed on just about any type of computer running just about any software quickly and easily, without regard to the ports available on that computer. Although the currently implemented embodiments of this invention use TCP/IP, those skilled in the art could easily adapt this invention to be implemented using other networking protocols.

In addition to overcoming problems seen in the prior art, this system has another significant advantage. The system can use devices other than personal computers to control operable and manipulative devices. In theory, the system can be integrated with any communications device that is capable of generating DTMF tones, including telephony equipment. Indeed, one of the embodiments of the system is that it can be implemented relatively simply using a standard telephone, thus allowing an individual to control the devices attached to system with a touch-tone phone. This might be used, for example, to facilitate telephone sex. Of course, other forms of audio tones may be used for controlling signals and are considered part of this disclosure. These alternative systems would be easily implemented by those skilled in the art given the benefit of this disclosure.

The system has many potential applications. Any sort of electronic, electrical, or electromechanical device can, with the proper relay, be attached to the system, and any such device can be controlled remotely over a telecommunications network. In this context, the term telecommunications network should be understood to include networks such as the Internet, a specified local computer network, a telephone network, and/or an audio network.

Because the Universal Controller itself has no built-in firmware or microprocessor, any updates to a device or devices can be distributed in the form of software. The entire “intelligence” of the present invention lies in the chat software of the system, so integrating new features or capabilities into the system is as easy as distributing new software.

### SUMMARY OF THE INVENTION

The present invention is a system allowing a user to remotely control operable or manipulative devices through a telecommunications network and a Universal Controller interconnected with a host device. The Universal Controller receives signals in the form of audio (preferably DTMF) tones from the host device and controls the operable or manipulative devices as directed by these signals. The host device can be a personal computer, a touch-tone telephone, or any communications device that is capable of generating audio tones.

The present invention also includes a method allowing a user to remotely control devices through an acoustically driven Universal Controller. The method uses a Universal Device Driver connected to a host computer that responds to a TCP/IP or other networking protocol request from a client computer by displaying a notification and enabling a decision to accept or reject the request, whereby establishing a connection between the host computer and the client computer. After the connection is established, the method uses a Universal Controller, connected to the host computer, to control operable or manipulative devices in response to audio (preferably DTMF) tones.

As presently implemented, the method is characterized by the software adapting to a demand mode, and subsequently on demand to a command mode, whereby to enable the present invention to act on a command.

### DESCRIPTION OF THE DRAWINGS

The invention will now be described, by way of example only, with reference to the accompanying drawings in which:

FIG. 1 is a functional block diagram of the Universal Controller; and

FIG. 2 is a schematic diagram and a technical overview diagrammatic description of the Universal Controller.

### DETAILED DESCRIPTION OF THE PREFERRED EMBODIMENT

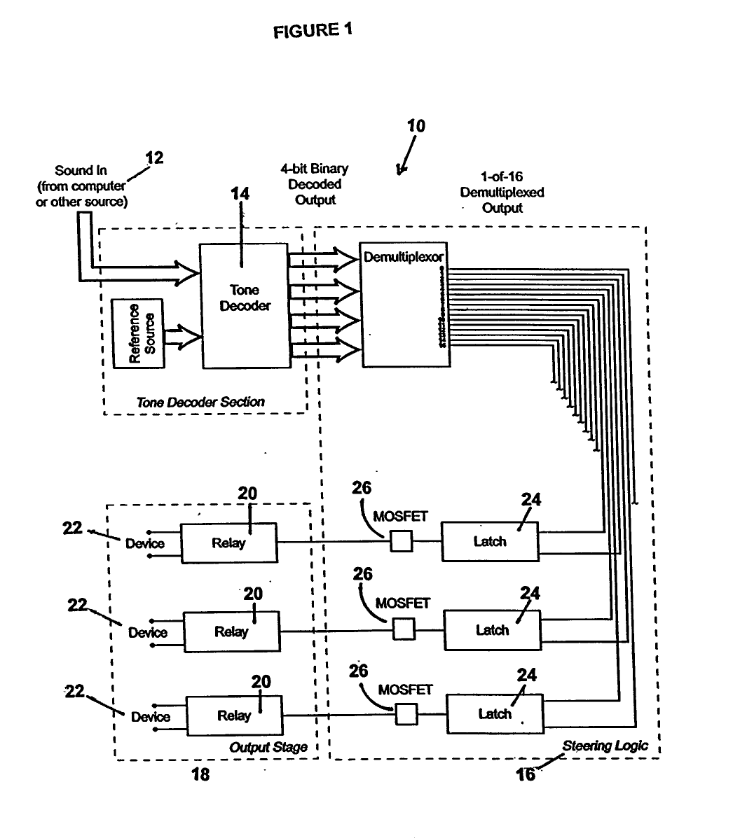

FIG. 1, the functional hardware block diagram, shows the Universal Controller (10) consists of a tone decoder section (14), a steering logic section (16), and an output section (18). A sound source (12) provides input to the Universal Controller. This sound source is preferably a computer but could also be a touch-tone telephone or another communications device that is capable of generating audio tones. In order to recognize distinctive patterns of audio tones from the sound source, the steering logic section (16) individually processes output from the tone decoder (14) in a distinct and particular way. This allows signals from the sound source to operate the appropriate relay(s) (20), to control predetermined devices (22) through the Universal Controller (10). It should be noted that the output section is established by the relays that control each device as commanded. Although relays are used in the preferred embodiment, those skilled in the art will recognize that other devices such as transistors could be used without departing from the present invention.

The present invention is essentially a system allowing a user to remotely control devices. The system comprises: a telecommunications network; a host device which serves as the sound source (12); a Universal Controller (10) connected to the host device; and operable or manipulative devices (22) connected to the Universal Controller. The Universal Controller receives signals in the form of audio (preferably DTMF) tones from the host device and controls the operable or manipulative devices as directed by these signals. The most novel innovation in the present invention is its audio-based interface. In the preferred embodiment, this allows a computer to control connected devices through the computer's sound output port.

In the preferred embodiment, the host device is a personal computer. A Universal Device Driver, a chat-based software program, uses a networking protocol to establish a connection between the host computer and a client computer. Although other protocols may be used, this embodiment of the invention is implemented utilizing a TCP/IP protocol. The Universal Device Driver converts signals from the client computer into DTMF tones relayed to the Universal Controller using the host computer's sound output port. The Universal Controller decodes the audio tones, analyzes the resulting signals, and operates the relays controlling attached operable or manipulative devices.

The invention is currently implemented using a set of 16 predetermined tones. The tones are used to indicate four bit binary numbers which correspond to decimal numbers (zero and fifteen). This allows the Universal Controller to provide a total of 16 preferred combinations.

In this embodiment, the Universal Controller is embodied by a single integrated circuit and includes a crystal oscillator, suitably connected to the steering logic circuitry (16). The steering logic circuitry is designed to receive the output of a tone decoder and to actuate the relays (20) on the basis of the output. The relays control the operable or manipulative devices (22).

One feature of the preferred embodiment of the invention is that Universal Device Driver permits chatting between the host computer and the client computer. The software also provides users with interface elements that represent commands, which can be transmitted to the device driver. This allows the user of the client computer to send signals via the Universal Device Driver to the Universal Controller to control connected operable and manipulative devices. For example, the user of the client computer could send a signal to the Universal Device Driver which would be interpreted as “Switch on the second device connected to the unit”. The software also contains logic so as to distinguish between a “chat message” and a “command message” which will contain a command for the Universal Device Driver to act upon.

A latching circuitry (24) is provided to hold the respective relays in a predetermined order even at the conclusion of the command tone. Semiconductors, in this embodiment MOSFET devices (26), are provided to act as digital switches that actuate the relays and cooperate with corresponding switches to control each operable or manipulative device.

The present invention as disclosed in the preferred embodiment is adapted for the Universal Controller unit to control at least three operable or manipulative devices. These devices are operable at varying functional speeds where the speeds of operation are predetermined. Those skilled in the art will immediately recognize this invention can be easily modified to operate any number of devices with any variety of functions.

A further novel aspect of the present invention is that it provides for transmitting in a dual communication channel mode in the form of instant messenger chat messages and commands, so as to control operable or manipulative devices over the same network connection simultaneously utilizing the same software.

In another embodiment of the invention, the host device can be a touch-tone telephone. Consequently, the Universal Controller would enable a person at one end of a telephone line to control operable or manipulative devices located at the other end of the telephone line while simultaneously carrying out a conversation with a person also present at the remote location. It should be noted that the individual buttons of a touch-tone telephone produces each of the DTMF tones in this embodiment of the present invention.

The present invention also provides a method allowing a user to remotely control devices through an acoustically driven Universal Controller. The invention method uses a Universal Device Driver connected to a host computer that responds to a networking protocol (preferably TCP/IP) request from a client computer by displaying a notification and enabling a decision to accept or reject the request, whereby establishing a connection between the host computer and the client computer. The Universal Device Driver uses the host computer's sound output port to send audio (preferably DTMF) tones to a Universal Controller. The Universal Controller controls operable or manipulative devices in response to the audio tones.

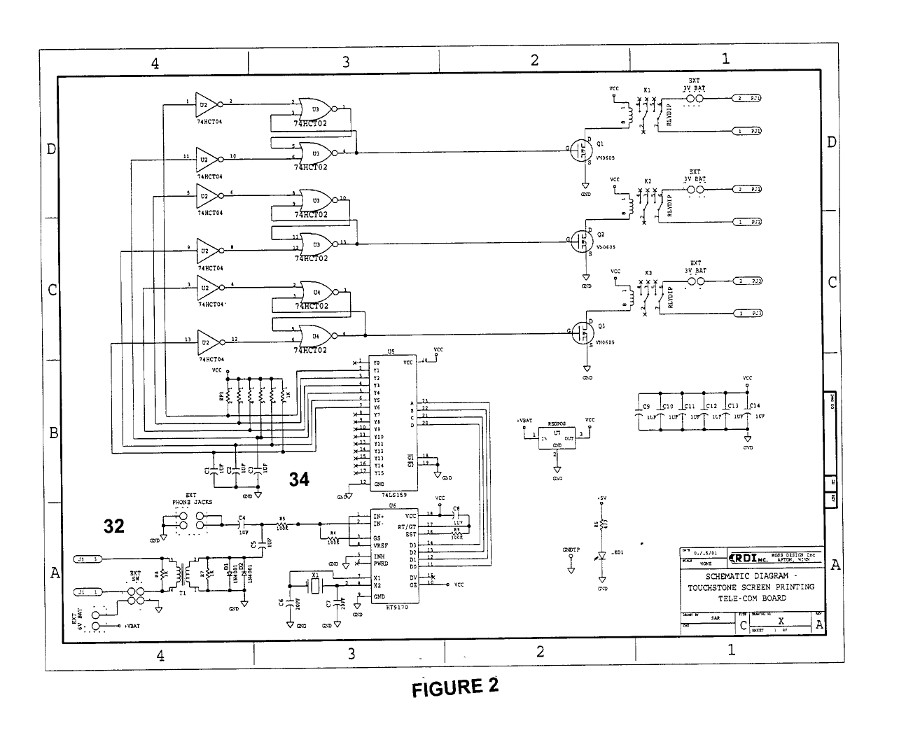

FIG. 2 provides a technical overview and description by a schematic diagram of the Universal Controller circuitry. The circuitry located at and designated (32) enables connection of the Universal Controller to sound sources such as a host computer or a telephone apparatus. The decoding logic of this circuitry is located at and designated (34). The remainder of the diagram constitutes the logic steering circuit and the relays. Preferably, the interface through which the Universal Controller unit is connected to a host computer is a standard ⅛″ stereo phone jack. The Universal Controller unit contains batteries, which power it and the devices.

The present invention also permits what is popularly known as “Cybersex”, in which two or more people on a computer network such as the Internet engage in real time conversation on sexually explicit topics. The Universal Controller has been arranged and adapted to operate a set of sex toys, such as vibrators, by remote control over a computer network.

What is claimed is:

1. A system, allowing a user to remotely control devices, comprising:
a telecommunications network;
a host device;
a Universal Controller connected to the host device; and
operable or manipulative devices connected to the Universal Controller;
wherein the Universal Controller receives signals in the form of audio tones from the host device and controls the operable or manipulative devices as directed by these signals.

2. A system as claimed in claim 1, wherein the telecommunications network utilizes a Transmission Control Protocol/Internet Protocol (TCP/IP) or another network protocol.

3. A system as claimed in claim 1 wherein the host device is a computer which:
links to another computer or computers (client computer(s)) located elsewhere and;
transmits audio tones to the Universal Controller in response to signals received from the client computer(s).

4. A system as claimed in claim 3, wherein the host computer and the client computer(s), when linked through a defined software, are further adapted for dialogue between computer users.

5. A system as claimed in claim 1, wherein the host device is an ordinary telephone.

6. A system as claimed in claim 5, wherein the Universal Controller is further adapted to enable a person at one end of a telephone line to communicate with another person at the other end of the telephone line while the Universal Controller is receiving signals in the form of audio tones over the telephone line and controlling the connected operable or manipulative devices as directed by the signals.

7. A system as claimed in claim 1 wherein the audio tones received from the telecommunications network by the Universal Controller consist of a predetermined set of audio tones referred to as “Dual Tone Multi-Frequency” or DTMF tones.

8. A system as claimed in claim 7, wherein the buttons of a touch-tone telephone produce each tone of the DTMF tones.

9. A system as claimed in claim 8, wherein there is a set of 16 such predetermined set of audio tones adapted to be responsive by a four-bit binary number on their outputs which corresponds to a decimal number between zero and fifteen, whereby to provide a total of 16 preferred combinations.

10. A system as claimed in claim 1, wherein the Universal Controller is a single integrated circuit and includes a crystal oscillator.

11. A system as claimed in claim 1, wherein the Universal Controller may be linked to multiple operable or manipulative devices, but preferably to at least three operable or manipulative devices with varying functions or speeds.

12. A system as claimed in claim 11, wherein the Universal Controller includes a tone decoder section, steering logic circuitry, and an output section with relays that control the connected operable or manipulative devices.

13. A system as claimed in claim 12, wherein the Universal Controller: receives signals in the form of audio tones from the host device; processes the audio tones in the tone decoder section; and, on the basis of the output of the tone decoder, uses the steering logic circuitry to actuate the relays controlling the operable or manipulative devices connected to the Universal Controller.

14. A system as claimed in claim 13, wherein the steering logic circuitry includes a demultiplexer that takes a four-bit binary output from the tone decoder to produce a single output on one of sixteen lines so that the active line corresponds to the respective binary number produced by the tone decoder.

15. A system as claimed in claim 14, wherein a latching circuitry is provided to hold the respective relays in a predetermined order even at the conclusion of a command tone.

16. A system as claimed in claim 15, wherein MOSFET devices are provided to act as digital switches that actuate the relays that co-operate with corresponding switches to control each of the connected operable or manipulative devices.

17. A system as claimed in claim 1, wherein the system provides for transmitting in a dual communication channel mode in the form of instant messenger chat messages and commands, so as to control operable or manipulative devices over the same network connection simultaneously utilizing the same software.

18. A system as claimed in claim 1, characterized in that the connected operable or manipulative devices are a set of sex toys such as vibrators.

19. A system as claimed in claim 1, characterized by allowing the control of sex toys over a telecommunication network.

20. A system as claimed in claim 19, characterized by the use of client software, which communicates over a computer network, whereby the client software enables the remote control of sex toys over the network.

21. A system allowing a user to remotely control devices through an acoustically driven Universal Device Driver and Universal Controller, which includes a specific tone decoder circuit adapted to recognize and establish different and distinct patterns of audio tones, whereby to respond to established audio tones, and thus control operable or manipulative devices

22. A system as claimed in claim 21, wherein the Universal Controller is connected to a host computer sound card or sound output port, so as to provide the tone decoder circuitry for each specific audio tone received from the host personal computer sound card or sound output port, the Universal Device Driver operable so as to trigger the tone decoder circuitry to generate electrical signals to actuate relays that control the operable and manipulative devices connected to the Universal Controller.

23. A system as claimed in claim 21, wherein the Universal Device Driver includes specifically designed software utilizing any networking protocol but preferably a TCP/IP (Transmission Control Protocol/Internet Protocol) that permits messaging functionality which enables information flow between computers, so as to establish a link between a host computer and a client computer, and to enable an acceptance or rejection of a request for a chatting or a command message.

24. A method allowing a user to remotely control devices through an acoustically driven Universal Controller, wherein the method includes:
using a Universal Device Driver connected to a host computer that responds to a TCP/IP (Transmission Control Protocol/Internet Protocol) or other networking protocol request from a client computer by displaying a notification and enabling a decision to accept or reject the request, whereby establishing a connection between the host computer and the client computer; and
using a Universal Controller, connected to the host computer, to control operable or manipulative devices in response to audio (preferably Dual Tone Multi Frequency (DTMF)) tones.

25. A method as claimed in claim 24, characterized by the Universal Device Driver adapting to a demand mode, and subsequently on demand to a command mode, whereby to enable the Universal Controller to act on the command.

26. A method as claimed in claim 25, characterized by the Universal Device Driver using the computer hardware to generate a particular and distinctive sound which is interpreted by a tone decoder circuit in the Universal Controller, where the resulting signal is processed by the digital logic circuit in the Universal Controller and used to control the relays within the Universal Controller which drive the connected operable and manipulative devices.

27. A method as claimed in claim 26, characterized by the system having software capable of transmitting both instant messenger style chat messages and commands to control an operable or manipulative device over the same network connection at the same time utilizing the same software.

28. A method as claimed in claim 24, characterized by operable or manipulative devices that are a set of sex toys such as vibrators.
